(19) United States
(12) Patent Application Publication
(10) Pub. No.: US 2008/0301587 A1
(43) Pub. Date: Dec. 4, 2008

(54) Control System for a Motor Vehicle

(75) Inventors: Markus Baumann, Stuttgart (DE); Volker Hellwig, Stuttgart (DE); Carla Knoop, Stuttgart (NL); Armin Zachay, Rechberghausen (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/584,085

(22) PCT Filed: Dec. 4, 2004
(86) PCT No.: PCT/EP04/13806

§ 371 Date: Oct. 9, 2007

(30) Foreign Application Priority Data
Dec. 23, 2003 (DE) 103 60 661.0

(51) Int. Cl. G06F 3/048

(52) U.S. Cl. 715/841

(57) ABSTRACT

A control system for a motor vehicle having a manual operating means having a plurality of adjustment degrees of freedom for selecting and/or activating entries in a menu structure having a plurality of menu levels, and a screen display (2) having a plurality of display areas (210 to 250) for displaying the menu structure, the display areas (210 to 250) each having at least one field for displaying one of the entries, a plurality of entries (E3 to E11) being arranged in a first display area (230.2) which is in the form of a list in an active display area (210 to 250) on at least one menu level. An (n+1)th display area (230.3) can be activated and displayed by activating at least one of the entries (E1 to E11) in an nth display area (230.2).

### BACKGROUND AND SUMMARY OF THE INVENTION

The invention relates to a control system for a motor.

Multimedia control systems are increasingly employed in modern vehicles. The command system in the Mercedes-Benz S-Class is mentioned here by way of example.

German Patent Document DE 197 52 056 A1 describes a control system of the generic type, in particular for a motor vehicle. In this control system, two display areas are displayed on a screen display in a menu structure having a plurality of menu levels. A first display area is arranged in the form of a frame around the second display area. On a first menu level, eight fields having entries which correspond to executable applications and are arranged vertically and horizontally are displayed in the first display area. An entry is selected by pushing or tilting the manual operating means with a plurality of adjustment degrees of freedom in the direction of the position of the corresponding entry in the first display area. Pressing the manual operating means activates a selected entry. Following activation, a plurality of entries which are arranged vertically and are assigned to the activated entry on the first menu level are displayed in the second display area on a second menu level. The entries which are displayed in the second display area are selected by rotating the manual operating means and are activated by pressing the manual operating means. The activated second display area and the second menu level are left by pushing or tilting the manual operating means in the direction of a position of one of the entries in the first display area. The control system is then in the first display area on the first menu level.

It is an object of the invention to specify an improved control system for a motor vehicle, which system enables intuitive control and reduces the amount of distracting information.

The invention is based on the idea that, in the case of a plurality of entries being arranged in an nth display area, which is in the form of a list, on at least one menu level, an (n+1)th display area can be activated and displayed in an active display area by activating at least one of the entries in said nth display area. In this case, the (n+1)th display area is displayed, beside aside the nth display area or in such a manner that it at least partially overlaps the nth display area, on the screen display in the active display area, n being a natural number.

The (n+1)th display area is arranged on the screen display on the basis of the available free space, for example.

The (n+1)th display area may likewise be in the form of a list having at least one entry.

When displaying the recently activated (n+1)th display area, a plurality of display areas may be at least partially overlapped.

The (n+1)th display area may, for example, be in the form of a list which has at least one entry and shifts the entries in the list in the nth display area downward or upward if the nth display area is in the form of a vertical list. If the nth display area is in the form of a horizontal list, the entries in the nth display area may be shifted to the left or right by the (n+1)th display area.

The (n+1)th display area may, for example, be in the form of a parameter area for setting a parameter, said parameter area replacing the entry, which activates it, in the list in the nth display area.

In one possible embodiment, the (n+1)th display area has the same width as the nth display area.

In one particularly advantageous development of the invention, at least a display area which was activated last is closed by operating the manual operating means with an adjustment degree of freedom which is orthogonal to the orientation of the entries in the display area which was activated last. All of the activated display areas are simultaneously closed in the case of an operating direction away from the triggering display area, and only the display area which was activated last is closed by an operating direction toward the triggering display area, and the triggering display area is activated for a new selection of an entry.

### BRIEF DESCRIPTION OF THE DRAWINGS

Advantageous embodiments of the invention are described below and are illustrated in the drawings, in which:

FIG. 1 shows a block diagram of a control system for a motor vehicle;

FIG. 2 shows a diagrammatic illustration of a screen display as shown in FIG. 1 on a first menu level;

FIGS. 3a and 3b each show a diagrammatic illustration of lists on the screen display as shown in FIG. 1;

FIGS. 4a and 4b each show another diagrammatic illustration of lists on the screen display as shown in FIG. 1; and

FIGS. 5a and 5b each show another diagrammatic illustration of lists on the screen display as shown in FIG. 1.

### DETAILED DESCRIPTION OF THE DRAWINGS

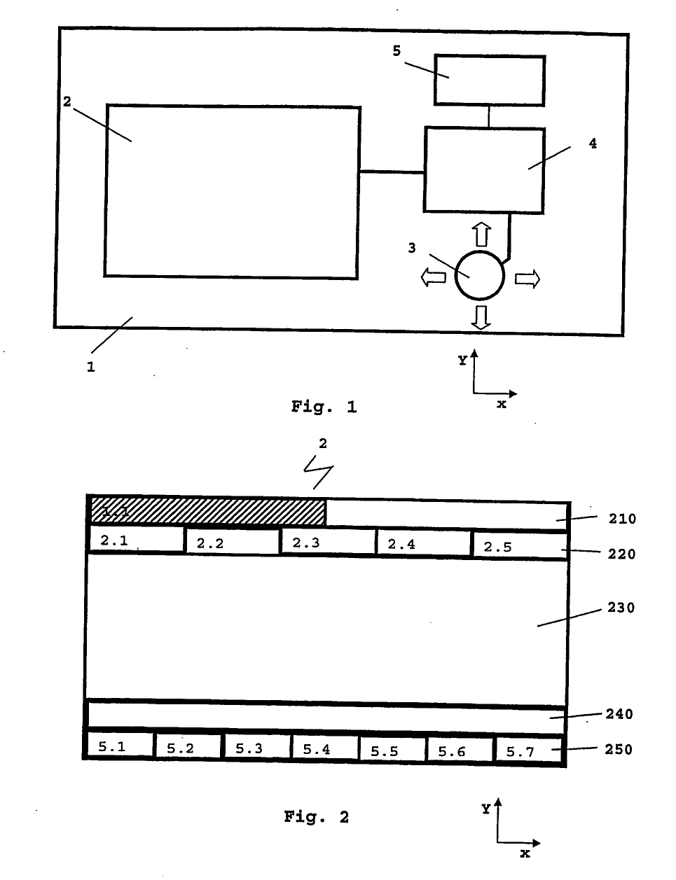

As can be seen in FIG. 1, the control system 1 for a motor vehicle comprises a screen display 2, a manual operating means 3, a control and evaluation unit 4 and a plurality of vehicle systems such as a navigation system, a heating and air conditioning system, a mobile telephone, a video system, an audio system etc. which are illustrated together as an element 5. The vehicle systems transmit signals to the evaluation and control unit 4, the control and evaluation unit 4 using these signals to determine current system states. All applications and/or functions and/or subfunctions and/or options and/or status displays on various menu levels of a menu structure are controlled using the manual operating means 3. The latter has seven adjustment degrees of freedom for selecting and/or activating entries which are displayed in an active display area. Said operating means can be pushed in four directions as shown by the arrows in FIG. 1, i.e. in a positive x-direction, a negative x-direction, a positive y-direction or a negative y-direction. In addition, it can be rotated clockwise or anticlockwise about a z-axis, which is not illustrated and is perpendicular to the plane of the drawing, and can be pressed in the direction of the negative z-direction, i.e. into the plane of the drawing.

Rotating the manual operating device 3 clockwise moves a cursor on the screen display 2 to the right or downward on the basis of a horizontal or vertical orientation of the entries which are displayed on the screen display 2, and rotating the operating device anticlockwise moves the cursor to the left or upward. Pushing the manual operating device 3 upward in FIG. 1, i.e. forward in the direction of the windshield, i.e. in the positive y-direction, moves the cursor on the screen display 2 upward, and pushing said operating device downward in FIG. 1, i.e. backward, in the negative y-direction, moves the cursor on the screen display 2 downward. Pushing said operating device to the right, i.e. in the positive x-direction, moves the cursor on the screen display 2 to the right, and pushing said operating device to the left, i.e. in the negative x-direction, moves the cursor to the left. An entry which is displayed on the screen display 2 is selected and/or activated by pushing or rotating the manual operating means 3. The manual operating device 3 may be rotated about the z-axis in a manner that is redundant to vertically pushing said operating means along an axis, i.e. in the y-direction, or to horizontally pushing said operating means along an axis, i.e. in the x-direction. In this case, the pushing direction for selecting an entry corresponds, according to the invention, to the orientation of the entries which are displayed in the active display area. The pushing direction which is respectively orthogonal to the pushing direction for selection results in the active display area being left. In addition, it may be necessary to press the manual operating device 3 in order to activate a selected entry.

As can be seen in FIG. 2, the screen display 2 include, on a first menu level, a graphical basic structure of five horizontal display areas 210 to 250 which are arranged vertically. This graphical basic structure is constant over the plurality of various menu levels in the menu structure. The screen display 2 is, for example, in the form of an eight inch screen having an aspect ratio of 15:9. The graphical basic structure of at least one first display area of the display areas 210 to 250 of the screen display 2 is constant over the plurality of various menu levels in the menu structure. In FIG. 2, the display areas 210, 220, 240 and 250 are in the form of first display areas of this type.

The graphical basic structure of at least one second display area of the display areas 210 to 250 can be varied over the plurality of various menu levels in the menu structure on the basis of an activated application and/or function and/or subfunction and/or option and/or status display. In FIG. 2, the display area 230 is in the form of such a second display area. The graphical configuration of this central display area 230 may be very different.

One or more horizontally arranged entries 1.1 to 5.7 may be respectively displayed in the four display areas 210, 220, 240 and 250 which are in the form of first display areas. By way of example, the display areas 210, 220, 240 and 250 in FIG. 2 each include a different number of entries on the first menu level. The first display area 210 thus includes one entry 1.1, the second display area 220 comprises five entries 2.1 to 2.5, the fourth display area does not include an entry and the fifth display area comprises seven entries 5.1 to 5.7. In FIG. 2, the first display area 210 has been activated and the hatched entry 1.1 has been selected. The hatched illustration is intended to indicate that the cursor is on the entry 1.1.

The entries 1.1 to 5.7 in the display areas 210 to 250 which are displayed on the screen display 2 may be arranged according to the importance of their contents or the frequency with which they are used. The width of the individual fields for displaying the entries 1.1 to 5.7 depends, for example, on the length of the longest entry when the entries are arranged vertically. The width of the fields may additionally or alternatively depend on the number of fields in a display area.

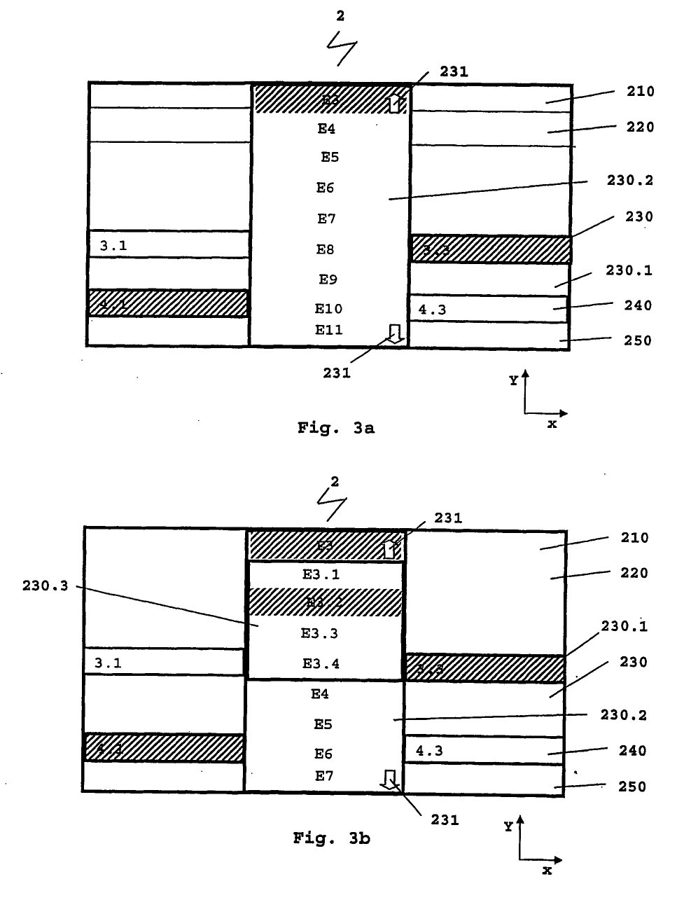

FIG. 3a shows a display area 230.2 which is in the form of a vertical submenu list and was opened by activating the entry 3.3 in a first submenu 230.1 in the third display area 230. The first submenu 230.1 was activated by activating the entry 4.1 in the fourth display area. The submenu list displayed in the display area 230.2 includes a plurality of entries, nine entries E3 to E11 of which have been illustrated and the entry E3 has been selected. Arrows 231 indicate that there are even more entries in the submenu list which may be selected. Pressing the manual operating means 3 activates the entry E3 and, as illustrated in FIG. 3b, opens a display area 230.3 which is in the form of a list. This display area 230.3 shifts the entries in the submenu list in the display area 230.2 downward. The entries E3.1 to E3.4 in the display area 230.3 are assigned to the entry E3 in the display area 230.2. The entry E3.2 has been selected in the example shown in FIG. 3b. The hatched design of fields containing entries indicates that these entries have been selected and/or activated.

In the exemplary embodiment shown, the display area 230.3 which is in the form of a list directly adjoins the associated entry E3. In an alternative embodiment, the entry E3 which activates the display area 230.3 is covered by the display area 230.3. A first entry E3.1 in the display area 230.3 is then in the place of the entry E3.

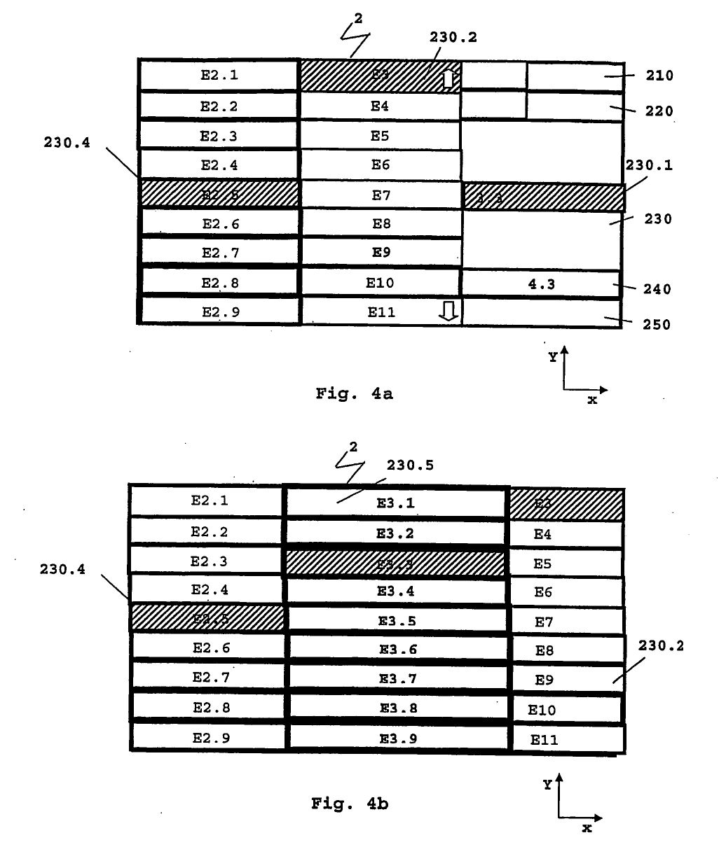

FIG. 4a shows an alternative embodiment of the invention after selecting and activating the entry 3.3 in the display area 230.2 which is in the form of a vertical submenu list and was opened by activating an entry 3.3 in the first submenu 230.1 in the third display area 230. Pressing the manual operating means 3 activates the entry E3 and activates a further display area 230.4, as illustrated in FIG. 4a. This display area 230.4 is likewise in the form of a vertical list having a plurality of entries 2.1 to 2.9, of which the entry 2.5 has been selected. Since there is sufficient space on the screen display 2, the further display area 230.4 is displayed beside the display area 230.2. One of the entries 2.1 to 2.9 may be selected, for example, by vertically pushing the operating means 3 in the positive or negative y-direction or by rotating the operating means 3 clockwise or anticlockwise about the z-axis. Pressing the operating means 3 activates the selected entry and activates a further display area 230.5, as can be seen in FIG. 4b. This further display area is likewise in the form of a vertical list having a plurality of entries E3.1 to E3.9, one of which can be selected and activated by means of corresponding operation of the manual operating means 3. Since the space on the screen display does not suffice to display all three display areas 230.2, 230.4 and 230.5 in full, the display area 230.5 which was activated last partially overlaps the display area 230.2 which was activated first, as can be seen in FIG. 4b. If the available space on the screen display 2 suffices to display all of the activated display areas 230.2, 230.4 and 230.5, the latter are all displayed in full, an activated display area preferably adjoining the display area which triggers it.

If, for example, a first display area 230.2 which activates a second display area 230.4 is arranged approximately in the center of the screen display 2, the second display area 230.4 which is activated by said first display area may be arranged to the left or right of the first display area 230.2. If a third display area 230.5 is activated by the second display area 230.4, the display areas 230.2 and 230.4 which have already been activated may be shifted to the left on the screen display 2 if the second display area 230.4 is displayed to the right of the first display area 230.2, and the third display area is then arranged to the right of the second display area 230.4. If the second display area is displayed to the left of the first display area 230.2, the display areas 230.2 and 230.4 which have already been activated are shifted to the right and the third display area 230.5 is arranged to the left of the second display area 230.4. If the space on the screen display 2 does not suffice to display all of the activated display areas 230.2, 230.4 and 230.5 in full, the third display area 230.5 is arranged beside the second display area 230.4 and at least partially overlaps the first display area 230.2 which was activated first, as can be seen in FIG. 4b.

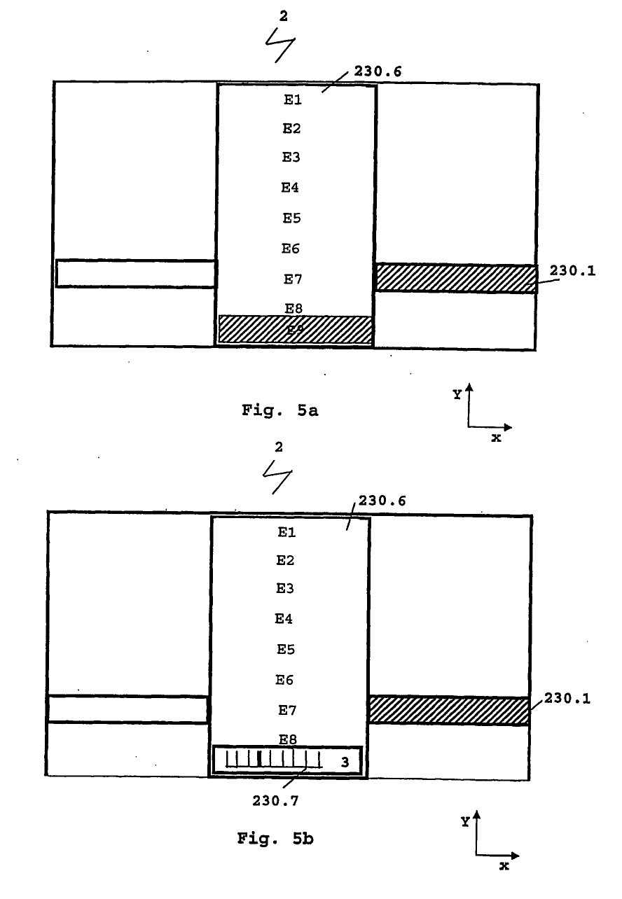

FIG. 5a shows a display area 230.6 which is in the form of a vertical submenu list and was opened by activating an entry 4.3 in the first submenu 230.1 in the third display area 230. The submenu list which is displayed in the display area 230.6 comprises, by way of example, nine entries E1 to E9, of which the entry E9 has been selected. Pressing the manual operating means 3 activates the entry E9 and, as illustrated in FIG. 5b, opens a display area 230.7 which is in the form of a parameter area. This display area 230.7 replaces the entry E9, which activates it, in the submenu list 230.6. A parameter which can be set in the parameter area 230.7, for example for adjusting the volume or a fan stage etc., is assigned to the entry E9 in the display area 230.6. The parameter which can be set can be set, using the manual operating means 3, by means of appropriate adjustment movements which correspond to the orientation of the parameter. The parameter area 230.7 is adjusted, for example, by horizontally pushing the operating means 3 in the positive or negative x-direction or by rotating the operating means 3 clockwise or anticlockwise about the z-axis. Pressing the operating means 3 stores the parameter value which has been set and leaves the activated parameter area 230.7. The screen display 2 then corresponds to the representation shown in FIG. 5a again.

In an alternative embodiment, the display area 230.7 may adjoin the entry E9 which activates it or may shift the other entries in the display area 230.6 upward or downward.

In the case of a horizontal arrangement (not shown) of the entries in a submenu list, the entries are selected by horizontally pushing the operating means 3 in the positive or negative x-direction or by rotating the operating means 3 clockwise or anticlockwise about the z-axis. A further list which is opened in the submenu list then shifts the entries in the submenu list in the positive or negative x-direction.

An activated display area is left, for example, by activating an entry with corresponding function triggering in this display area or by operating the manual operating means 3 with an adjustment degree of freedom which is orthogonal to the orientation of the entries in the display area which was activated last. All of the activated display areas are simultaneously closed in the case of an operating direction away from the triggering display area, and only the display area which was activated last is closed by an operating direction toward the triggering display area, and the triggering display area is activated for a new selection of an entry.

If, for example in the case of the screen display 2 illustrated in FIG. 4b, the manual operating means 3 is pushed in the negative x-direction, i.e. in the direction of the path on which the third display area 230.5 was activated and opened, the display area 230.5 is left and closed and the second display area 230.4 is activated again. The cursor is then, for example, on the entry from which the third display area 230.5 was activated, i.e. on the entry E2.5 in the display area 230.4. The representation on the screen display 2 then corresponds again to the representation shown in FIG. 4a.

If, in the case of the screen display 2 illustrated in FIG. 4b, the manual operating means 3 is pushed in the positive x-direction, both the third display area and the second and first display areas 230.4 and 230.2 are left and closed and the display area 230.1 from which the first display area 230.2 was activated is activated again. The cursor is then, for example, on the entry from which the first display area 230.2 was activated, i.e. on the entry 3.3 in the display area 230.1.

The inventive display of a second display area in addition to a first display area (which is in the form of the list) conveys to the user that he can perform adjustment movements similar to those in the superordinate first display area in order to select an entry or to set a parameter in the second display area. In addition, the assignment of the second display area to the entry, which activates it, in the first display area is displayed in such a manner that it can be clearly seen by the user. As a result, the respective entry or parameter can be intuitively selected and set and the active display area can be intuitively left.

1.-10. (canceled)

11. A control system (1) for a motor vehicle, said system comprising:
a manual operating device having a plurality of adjustment degrees of freedom for at least one and selecting and activating entries in a menu structure having a plurality of menu levels,
a screen display having a plurality of active display areas for displaying the menu structure, the active display areas each comprising at least one field for displaying one of the entries, wherein
a first plurality of said entries being arranged in a second display area which is in the form of a list in one of said active display areas on at least one menu level, and
an (n+1)th display area activated and displayed by activating at least one of said entries in an nth display area, wherein the (n+1)th display area is displayed beside the nth display area or in such a manner that it at least partially overlaps the nth display area, on the screen display in the active display area, and wherein
n is a natural number.

12. The control system as claimed in claim 11, wherein the (n+1)th display area is displayed on the screen display on the basis of available free space.

13. The control system as claimed in claim 11, wherein the (n+1)th display area is in the form of a list having at least one entry.

14. The control system as claimed in claim 11, wherein the (n+1)th display area at least partially overlaps a plurality of display areas.

15. The control system as claimed in claim 11, wherein the (n+1)th display area is displayed within the nth display area.

16. The control system as claimed in claim 15, wherein the (n+1)th display area, which is in the form of a list, shifts the plurality of said entries in the list of the nth display area downward or upward in the case of a vertical list or to the left or right in the case of a horizontal list.

17. The control system as claimed in claim 15, wherein the (n+1)th display area has the same width as the nth display area.

18. The control system as claimed in claim 11, wherein the (n+1)th display area is in the form of a parameter area for setting a parameter.

19. The control system as claimed in claim 18, wherein the (n+1)th display area, which is in the form of a parameter area replaces the entry, which activates it, in the list of the nth display area.

20. The control system as claimed in claim 11, wherein at least a last activated display area which was activated last is closed by operating the manual operating means with an adjustment degree of freedom which is orthogonal to the orientation of the entries in the last activated display area wherein all of the activated display areas are simultaneously closed in the case of an operating direction away from the triggering display area, and only the last activated display area is closed by an operation toward the triggering display area, and wherein the triggering display area is activated for a new selection of an entry.

21. The control system as claimed in claim 12, wherein the (n+1)th display area is in the form of a list having at least one entry.

22. The control system as claimed in claim 12, wherein the (n+1)th display area at least partially overlaps a plurality of display areas.

23. The control system as claimed in claim 13, wherein the (n+1)th display area at least partially overlaps a plurality of display areas.

24. The control system as claimed in claim 12, wherein the (n+1)th display area is displayed within the nth display area.

25. The control system as claimed in claim 13, wherein the (n+1)th display area is displayed within the nth display area.

26. The control system as claimed in claim 14, wherein the (n+1)th display area is displayed within the nth display area.

27. The control system as claimed in claim 16, wherein the (n+1)th display area has the same width as the nth display area.

28. The control system as claimed in claim 12, wherein the (n+1)th display area is in the form of a parameter area for setting a parameter.

29. The control system as claimed in claim 13, wherein the (n+1)th display area is in the form of a parameter area for setting a parameter.
